(19) United States
(12) Patent Application Publication
(10) Pub. No.: US 2017/0329454 A1
(43) Pub. Date: Nov. 16, 2017

(54) METHOD AND APPARATUS FOR TOUCH PANEL INPUT USING TOUCH PATTERN GROUPS

(71) Applicant: Samsung Electronics Co., Ltd., Gyeonggi-do (KR)

(72) Inventors: Hyunsuk CHOI, Daegu (KR); Minho KIM, Gyeongsangbuk-do (KR); Jiwoong OH, Seoul (KR)

(21) Appl. No.: 15/667,733

(22) Filed: Aug. 3, 2017

Related U.S. Application Data
(63) Continuation of application No. 14/630,842, filed on Feb. 25, 2015.

(30) Foreign Application Priority Data
Feb. 27, 2014 (KR) 10-2014-0023104

(51) Int. Cl. G06F 3/041; G06F 3/044

(52) U.S. Cl. CPC G06F 3/0416; G06F 3/044; G06F 2203/04106

(57) ABSTRACT

An apparatus includes: a first touch panel including a first touch pattern group formed in a first area of the first touch panel and a second touch pattern group formed in a second area of the first touch panel that surrounds the first area; and a first processor configured to detect an input to the first touch panel based on a first threshold and a second threshold, wherein the first threshold is used in detecting a first portion of the input performed in the first area and the second threshold is used in detecting a second portion of the input performed in the second area of the touch panel.

### CROSS-REFERENCE TO RELATED APPLICATION

This application is a Continuation of U.S. patent application Ser. No. 14/630,842 filed on Feb. 25, 2015 which claims priority from and the benefit under 35 U.S.C. §119(a) of Korean Patent Application No. 10-2014-0023104, filed on Feb. 27, 2014, which is hereby incorporated by reference for all purposes as if fully set forth herein.

### TECHNICAL FIELD

The present disclosure relates to electronic devices, and more particularly to a method and apparatus for touch panel input.

### BACKGROUND

Recent electronic devices such as mobile phones, smartphones, and tablet Personal Computers (PCs) are equipped with a display unit integrating an input unit and a touch panel. There are various types of touch panels including capacitive type, resistive type, electromagnetic type, and optical type.

Among them, capacitive type touch panels may be further classified into an analog type and digital type. The analog capacitive touch panels have a sensor electrode in the form of sheet and thus do not need a pattern in the sensing area while the digital capacitive touch panels needs a sensing electrode pattern.

The sensing electrode pattern has two axes for coordinate recognition so as to locate contact touch or proximal touch input. However, the edge area of the electronic pattern has a low touch recognition accuracy or rate as compared to other areas.

### SUMMARY

According to aspects of the disclosure, an apparatus is provided comprising: a first touch panel including a first touch pattern group formed in a first area of the first touch panel and a second touch pattern group formed in a second area of the first touch panel that surrounds the first area; and a first processor configured to detect an input to the first touch panel based on a first threshold and a second threshold, wherein the first threshold is used in detecting a first portion of the input performed in the first area and the second threshold is used in detecting a second portion of the input performed in the second area of the touch panel.

According to aspects of the disclosure, a method is provided comprising establishing a connection between a first electronic device and a second electronic device; detecting, by the first electronic device, a first signal generated using a first touch panel of the first electronic device; receiving, from the second electronic device, a second signal that is generated using a second touch panel of the second electronic device; performing, by the first electronic device, an operation based on both the first signal and the second signal; wherein the first touch panel includes a first touch pattern group formed in a first area of the first touch panel and a second touch pattern group formed in a second area of the first touch panel that surrounds the first area.

According to aspects of the disclosure, an apparatus is provided comprising a first touch panel and a processor configured to: establish a connection with an electronic device; detect a first signal generated using the first touch panel; receive, from the electronic device, a second signal that is generated using a second touch panel of the electronic device; perform an operation based on the first signal and the second signal; wherein the first touch panel includes a first touch pattern group formed in a first area of the first touch panel and a second touch pattern group formed in a second area of the first touch panel that surrounds the first area.

### BRIEF DESCRIPTION OF THE DRAWINGS

FIG. 1 is a flowchart of an example of a process for forming a touch panel, according to aspects of the disclosure;

FIG. 2 is a diagram of an example of a touch panel, according to aspects of the disclosure;

FIG. 3A, FIG. 3B, FIG. 3C and FIG. 3D are diagrams illustrating an example of a first and second touch pattern groups, according to aspects of the disclosure;

FIG. 4A and FIG. 4B are cross-sectional diagrams illustrating an example of a first and second touch pattern groups, according to aspects of the disclosure;

FIG. 5 is a flowchart of an example of a process, according to aspects of the disclosure;

FIG. 6 is a flowchart of an example of a process, according to aspects of the disclosure;

FIG. 7 is a diagram illustrating an example of a method for processing touch input performed in the input cutoff area between two electronic devices, according to aspects of the disclosure;

FIG. 8 is a block diagram illustrating a touch input processing operation between the electronic devices, according to aspects of the disclosure;

FIG. 9 is a diagram illustrating a method for processing touch input that spans multiple devices, according to aspects of the disclosure; and

FIG. 10 is a block diagram of an example of an electronic device, according to aspects of the disclosure.

### DETAILED DESCRIPTION

Exemplary embodiments of the present disclosure are described with reference to the accompanying drawings in detail. Although the description is made with reference to particular embodiments, the present disclosure can be implemented with various modifications. Thus, it should be understood that there may be various equivalents and modified examples that can replace the embodiments described in the present specification and the configuration shown in the drawings. The same reference numbers are used throughout the drawings to refer to the same or like parts.

It will be understood that the expressions “comprises” and “may comprise” is used to specify presence of disclosed function, operation, component, etc. but do not preclude the presence of one or more functions, operations, components, etc. It will be further understood that the terms “comprises” and/or “has” when used in this specification, specify the presence of stated feature, number, step, operation, component, element, or a combination thereof but do not preclude the presence or addition of one or more other features, numbers, steps, operations, components, elements, or combinations thereof.

In the present disclosure, the expression “and/or” is taken as specific disclosure of each and any combination of enumerated things. For example, A and/or B is to be taken as specific disclosure of each of A, B, and A and B.

As used herein, terms such as “first,” “second,” etc. are used to describe various components, however, it is obvious that the components should not be defined by these terms. For example, the terms do not restrict the order and/or importance of the corresponding components. The terms are used only for distinguishing one component from another component. For example, a first component may be referred to as a second component and likewise, a second component may also be referred to as a first component, without departing from the teaching of the inventive concept.

Unless otherwise defined herein, all terms including technical or scientific terms used herein have the same meanings as commonly understood by those skilled in the art to which the present disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

According to an embodiment of the present disclosure, the electronic device has a communication function. Examples of the electronic device include a smartphone, a tablet Personal Computer (PC), a mobile phone, a video phone, an electronic book (ebook) reader, a desktop PC, a laptop computer, a netbook computer, a Personal Digital Assistant (PDA), a Portable Multimedia Player (PMP), an MP3 player, a mobile medical appliance, a camera, a wearable device (e.g. electronic glasses and Head Mounted Device (HMD)), an electronic cloth, an electronic bracelet, an electronic necklace, an electronic appcessory, an electronic tattoo, and a smart watch.

According to certain embodiments, the electronic device may be a smart home appliance equipped with a communication function. Examples of the smart home appliance include a Television (TV), a Digital Video Disk (DVD) player, an audio, a refrigerator, an air conditioner, a vacuum cleaner, an oven, a microwave oven, a laundry machine, an air cleaner, a set-top box, a TC box (e.g. Samsung HomeSync™, apple TV™, and Google TV™), a game console, an electronic dictionary, an electronic key, a camcorder, and an electronic frame.

According to certain embodiments, examples of the electronic device include a medical device (e.g. Magnetic Resonance Angiography (MRA), Magnetic Resonance Imaging (MRI), a Navigation device, a Global Positioning System (GPS) receiver, an Event Data Recorder (EDR), a Flight Data Recorder (FDR), a car infotainment device, electronic equipment for ship (e.g. maritime navigation device and gyro compass), aviation electronic device (avionics), security device, an industrial or home robot.

According to certain embodiments, examples of the electronic device may include furniture or part of building/construction which has a communication function, an electronic board, an electronic signature receiving device, a projector, and a metering device (e.g. water, electricity, and electric wave metering devices). According to an embodiment, the electronic device may be one or any combination of the above-enumerated devices. According to various embodiments, the electronic device may be a one or any combination of various devices. However, it is obvious to those in the art that the electronic device of the present disclosure is not limited to the above devices.

The present disclosure provides a touch panel and touch input processing method and apparatus of an electronic device that is capable of improving touch accuracy or recognition rate.

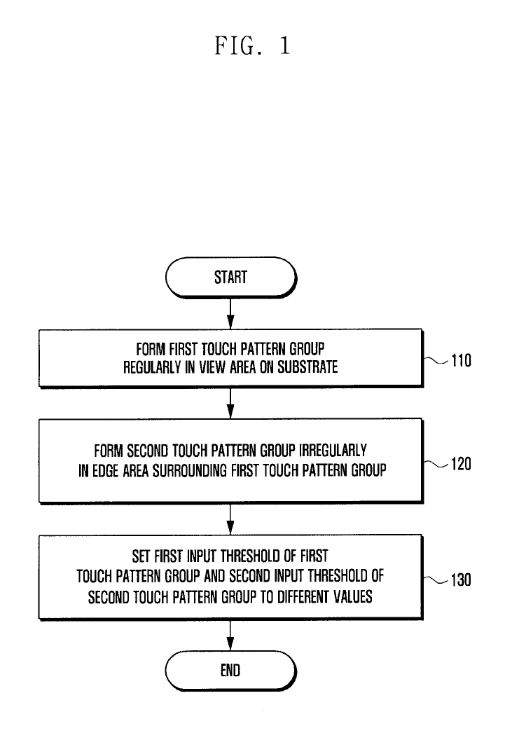

FIG. 1 is a flowchart of an example of a process for forming a touch panel, according to aspects of the disclosure.

In operation 110, a first touch pattern group is formed within the View Area (V/A) of a substrate of the touch panel. The V/A may display data such as text and image. The first touch pattern group may be formed at a regular interval. As used throughout the disclosure, the phrase “touch pattern” refers to an element in a touch panel which comes in contact (e.g., (direct or indirect) electrical contact, (direct or indirect) physical contact, with a user's finger, a stylus, and/or any other suitable object for entering input into the touch panel.

In operation 120, a second touch pattern group is formed in the edge area of the substrate surrounding the first pattern group. The edge area may include the area between the view area and the bezel area. The bezel area is a non-view area surrounding the edge of the view area and printed with one or any combination of various colors such as black, white, and pink to hide wirings, contact points, and pattern arranged in the non-view area. According to aspects of the disclosure, the edge area may include at least part of the boundary area included in the view area or a part of an inner bezel area formed to protect against backlight bleeding between the view area and the bezel area.

The second touch pattern group may include touch patterns formed at an irregular interval unlike the first touch pattern group. According to aspects of the disclosure, the second touch pattern group may be formed on the substrate on which the first touch pattern group is formed or on a substrate different from the substrate on which the first touch pattern group is formed.

The touch patterns in the first touch pattern group and the second touch pattern group may have any suitable type of shape. For example, the touch patterns in the first pattern group may be shaped like a line, a curved object, a diamond, a polygon a circle, a sector, a tooth, a star, etc. Similarly, the touch patterns in the second touch pattern group may be shaped like a line, a curved object, a diamond, a polygon a circle, a sector, a tooth, a star, etc. In some implementations, each of the touch patterns in the first touch pattern group may have a diamond shape, and each of the touch patterns in the second touch pattern group may have a triangular shape.

According to aspects of the disclosure, the touch patterns in the second touch pattern group may have a shape obtained by dividing a pattern of the first touch pattern group at a predetermined ratio. Also, the touch patterns in the second touch pattern group may have a shape obtained by extending a pattern of the first touch pattern group at a predetermined ratio.

In operation 130, the touch panel is incorporated into an electronic device. In some implementations, the electronic device may be configured to use different input thresholds for the first and second touch pattern groups. The input threshold is a standard to determine whether a signal generated by using a given touch pattern is the result of a valid input. However, the touch recognition rate is low at the edge area due to the physically narrow area as compared to the view area, it is necessary to set the input threshold to a value smaller than that in the view area so as to regards the low input detection value as a valid input. For example, if the first input threshold is set to 50, then the second input threshold value may be set to 30. In this case, the edge area determines the pressure with the detected input value equal to greater than 50 as a valid input while the edge area determines the pressure with the detected input value equal to or greater than 30 as a valid input. Accordingly, although the detected input value of the edge area is less than the first input threshold value, if it is greater than the second input threshold value, the electronic device determines the pressure as a valid input.

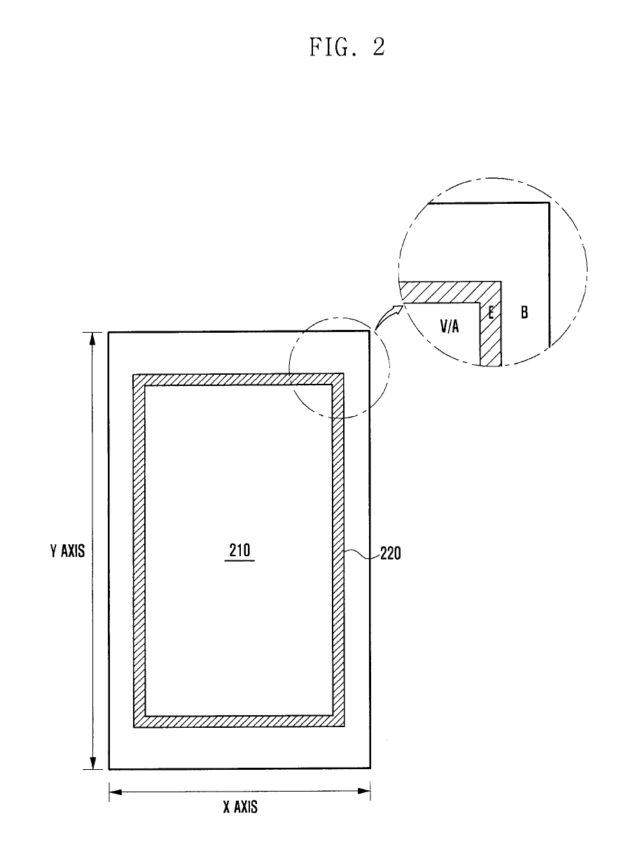

FIG. 2 is a diagram of an example of a touch panel, according to aspects of the disclosure.

Referring to FIG. 2, the view area (V/A) 210 is of displaying data such as texts and images. The bezel area (B) is a non-view area surrounding the edge of the view area (V/A). The edge area (E) 220 is the area between the view area (V/A) 210 and the bezel area (B). According to aspects of the disclosure, the edge area 220 may include at least part of the boundary included in the view area 210 or at least part of an inner bezel area formed to protect against backlight bleeding between the view area (V/A) 210 and the bezel area (B).

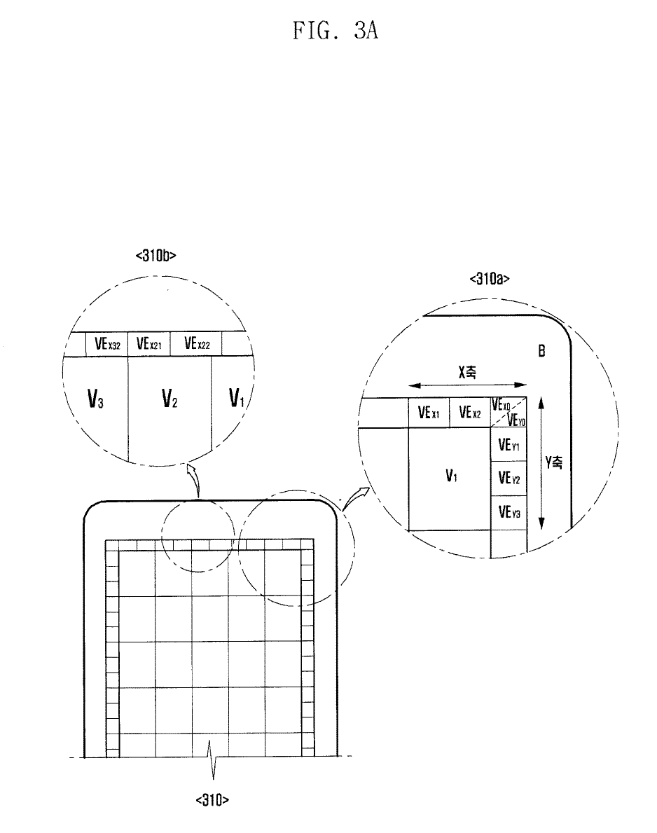

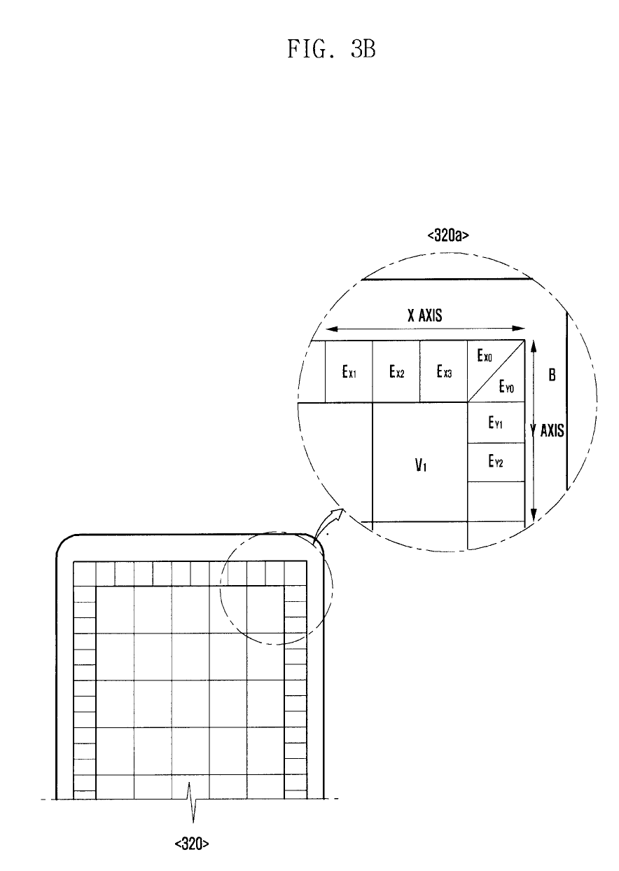

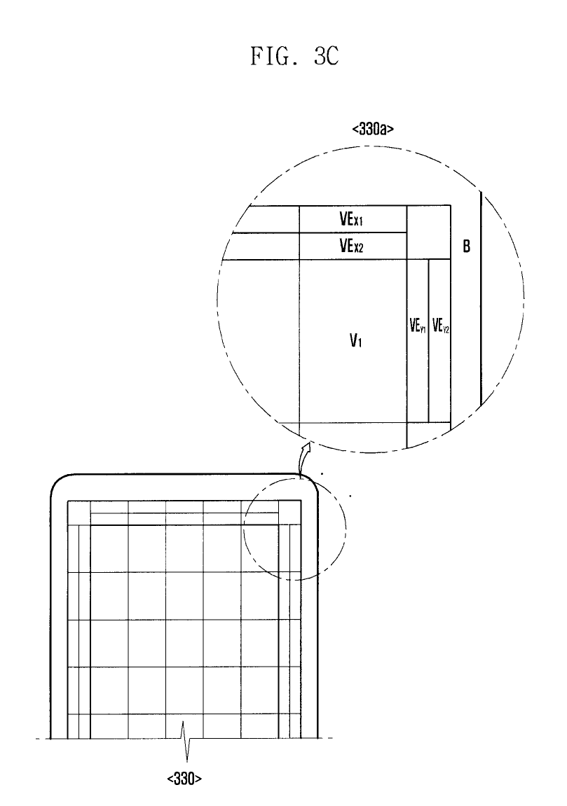

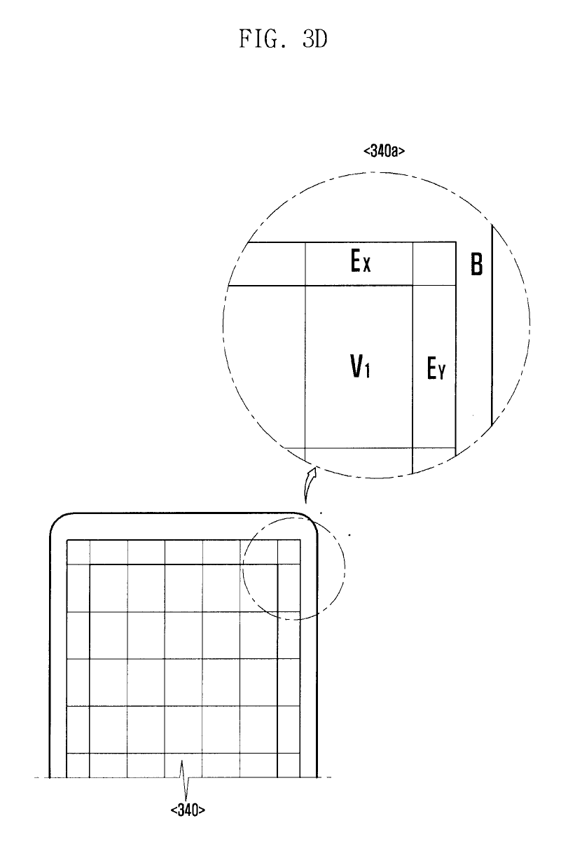

FIGS. 3A to 3D are diagrams illustrating an example of a first and second touch pattern groups, according to aspects of the disclosure.

Referring to FIG. 3A, the electronic device may configure the touch panel to have the first touch pattern group with the quadrangle pattern (V₁) at a regular interval and a second touch pattern group with the pattern formed at an irregular interval. The second touch pattern group may be formed in the edge area (VE) included in the view area. For example, the second pattern group 310a is formed by splitting the quadrangle pattern (V₁) into two segments (VEₓ₁ and VEₓ₂) on the X-axis and by splitting the quadrangle pattern (V₁) into three segments (VE_{y1}, VE_{y2}, and VE_{y3}) on the Y-axis. Also, the second touch pattern group 310a may be formed by splitting the quadrangle pattern (V₁) into segments (VEₓ₃₂, VEₓ₂₁, and VEₓ₂₂) irregularly. At this time, the electronic device may form a pattern at the corner area (VEₓ₀ and VE_{y0}) where the X-axis and Y-axis cross.

Referring to FIG. 3B, the electronic device may configure the touch panel 320 to have the first touch pattern group with the regular quadrangle pattern (V₁) and the second touch pattern group formed in the inner bezel area (E) an irregular interval. The inner bezel area is the edge area between the view area and the bezel area. For example, the second touch pattern group 320a is formed by splitting the quadrangle pattern (V₁) into three sections (Eₓ₁, Eₓ₂, and Eₓ₃) on the X-axis and by splitting the quadrangle pattern (V₁) into three sections (E_{y1}, E_{y2}, and E_{y3}) on the Y-axis. At this time, the electronic device may form a pattern at the corner area (Eₓ₀, E_{y0}) where the X-axis and Y-axis cross.

Referring to FIG. 3C, the electronic device may configure the touch panel 330 to have the first touch pattern group with the regular quadrangle pattern (V₁) and the second touch pattern group with the segments obtained by splitting the quadrangle pattern (V1) at a predetermined ratio in the first touch pattern group. At this time, the second touch pattern group may be formed in the edge area (VE) included in the view area. For example, the second touch pattern group 330a is formed with the segments (VEₓ₁ and VEₓ₂) obtained by splitting the quadrangle pattern (V1) at a predetermined ratio along the X-axis and the segments (VE_{y1}, VE_{y2}) obtained by splitting the quadrangle pattern (V1) at a predetermined ratio along the-Y axis.

Referring to FIG. 3D, the touch panel 340 may have the first touch pattern group formed with regular quadrangle patterns (V1) and the second touch pattern group formed in the inner bezel area (E) by extending one pattern of the first touch pattern group at a predetermined ratio. For example, the second touch pattern group 340a may have the pattern (Eₓ₁, E_{y1}) formed by extending the quadrangle pattern (V1) at a predetermined ratio.

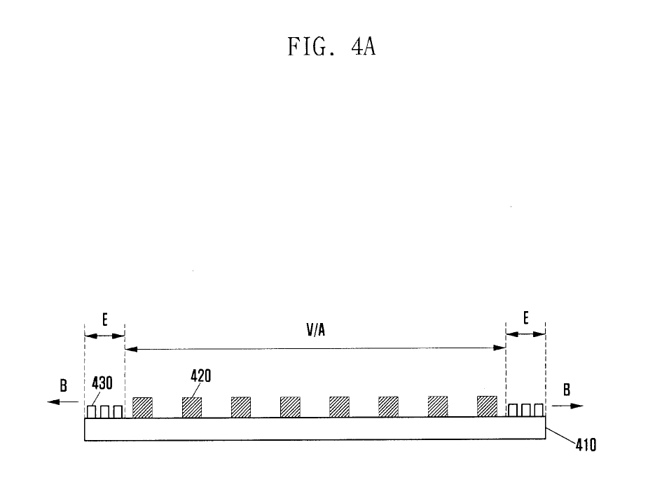

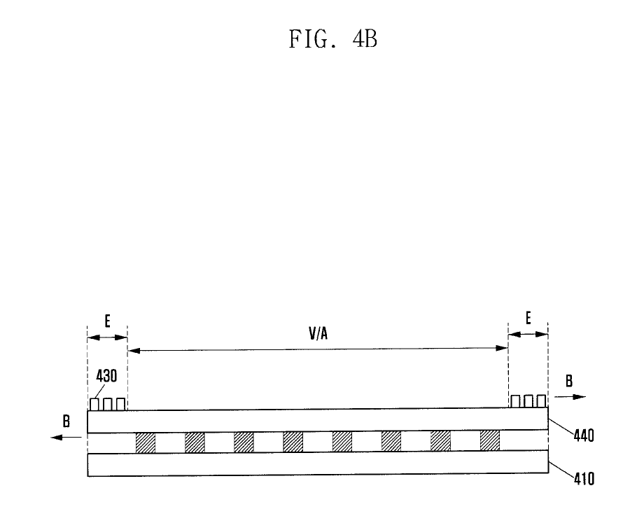

FIGS. 4A and 4B are cross-sectional diagrams illustrating an example of a first and second touch pattern groups, according to aspects of the disclosure.

Referring to FIG. 4A, the touch panel may be formed in such a way that both the first and second touch pattern groups 420 and 430 are formed on the first substrate 410. Referring to FIG. 4B, the touch panel may be formed in such a way that the first touch pattern group 420 is formed on the first substrate 410 and the second touch pattern group on the second substrate 440. Each of the first and second substrates 410 and 440 may be a printed circuit board including at least one or any combination of a Liquid Crystal Display (LCD), a Light Emitting Diodes (LED), a glass element, a device, a bracket, a reinforcement board, and a separate mounting plate, but not limited thereto.

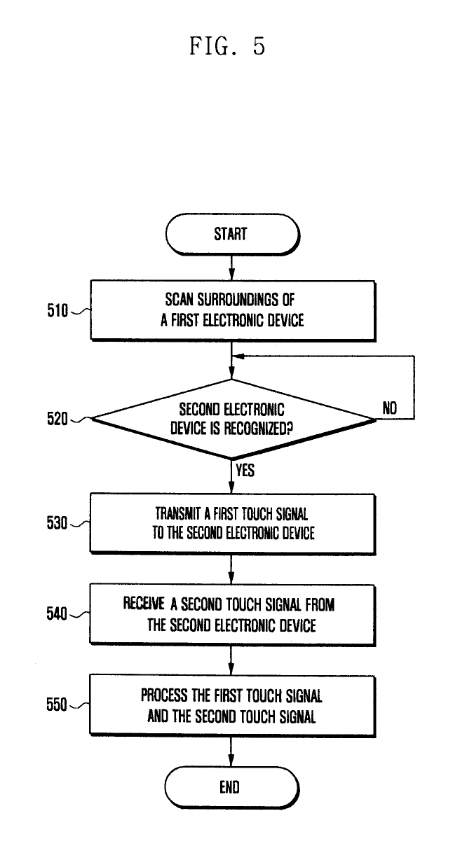

FIG. 5 is a flowchart of an example of a process, according to aspects of the disclosure. In operation 510, the electronic device scans the surroundings of the electronic device. At operation 520, the electronic device determines whether a second electronic device is recognized as a result of the scan. The electronic device may be connected with the second electronic device through a short range communication link and recognizes the connection of the second electronic device. The short range communication link may be established through one or any combination of a plurality of communication protocols including Wi-Fi, Bluetooth, and Near Field Communication (NFC).

In operation 530, if the second electronic device is recognized, the electronic device transmits to the second electronic device an indication of a first touch signal that is generated by a touch sensor of the electronic device. In operation 540, the electronic device receives from the second electronic device, an indication of a second touch signal that is generated by a touch sensor of the second electronic device. According to aspects of the disclosure, operations 530 and 540 may be performed simultaneously or sequentially but in a different order.

The touch sensor is implemented in the touch panel of the second electronic device which may be identical in type with or different form that of the host electronic device. The second touch signal may be identical with or different from the first touch signal. For explanation convenience, the signal detected at the host electronic device is referred to as “touch signal” and the signal detected at the second electronic device as “sensor signal.”

In operation 550, the electronic device processes the touch input using the first touch signal and the second touch signal. If the electronic device supports a proximity input function, the touch input may include a proximity input as well as the contact input.

According to aspects of the disclosure, the electronic device may detect an input cutoff area between the host electronic device and the second electronic device. The input cutoff area may include the bezel areas surrounding the view areas when the view areas of the host electronic device and the second electronic device are arranged correspondingly. That is, the input cutoff area may include the bezel areas of the host electronic device and the second electronic device. The host electronic device may process a touch input using the first touch signal and the second touch signal in the cutoff area. The electronic device also may calibrate the first touch signal and the second touch signal in the input cutoff area. The signal calibration is a pre-process for processing the touch input made in the input cutoff area efficiently. For example, the first touch signal and the second touch signal may be generated in the edge area of the host electronic device or the second electronic device. According to aspects of the disclosure, the host electronic device may share the touch input made in the input cutoff area with the second electronic device. For example, if the first touch signal is made with a gesture crossing the input cutoff area, the host electronic device transfers the touch signal to the second electronic device, receives the second touch signal generated by the touch sensor in correspondence to the touch signal, and executes a function pertaining to the first touch signal using based on the second touch signal.

According to aspects of the disclosure, the host electronic device may form a virtual neighbor touch panel in the input cutoff area. The electronic device may process the touch input made in the input cutoff area using at least one of the touch signal, the sensor signal, and the virtual touch signal detected on the virtual neighbor touch panel. According to a certain embodiment, the electronic device may calibrate the touch signal, the sensor signal, and the virtual touch signal and processes the touch input made in the input cutoff area using the calibrated signals.

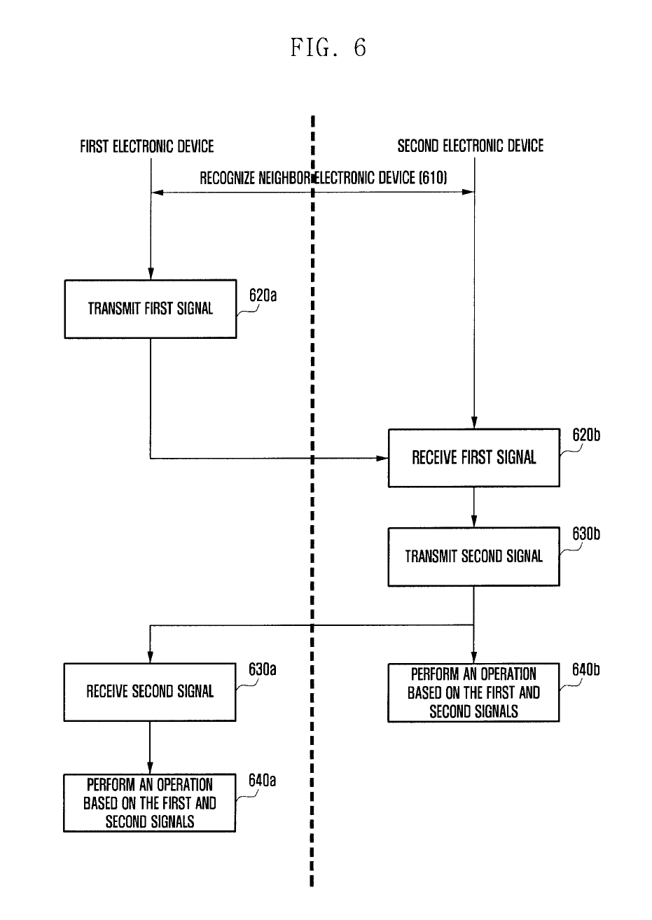

FIG. 6 is a flowchart of an example of a process, according to aspects of the disclosure.

In operation 610, the first electronic device discovers a second electronic device at operation 610. The second electronic device may also discover the first electronic device in a first.

For explanation convenience, the operations executed by the first electronic device are denoted by reference numbers ending with “a,” and the operations executed by the second electronic device are denoted by reference numbers ending with “b.”

In operation 620a, the first electronic device sends the second electronic device an indication of a first signal generated by a touch panel of the first electronic device.

In operation 620b, the second electronic device receives the indication of the first signal. In operation 630b, the second electronic device sends the first electronic device an indication of a second signal generated by a second touch sensor of the second electronic device. In some implementations, the touch sensor of the second electronic device may be a touch panel.

According to a certain embodiment, the touch signal and the sensor signal may be the signals generated in the input cutoff area as the bezel areas of the first and second electronic devices.

In operation 630a, the first electronic device receives the indication of the second signal. In operation 640a, the first electronic device performs an operation based on the first signal and the second signal.

In operation 640b, the second electronic device performs an operation based on the second signal and the first signal. In some implementations, in operations 640a and 640b, data including an icon and an audio file can be transferred from the first electronic device to the second electronic device according to the first and second signals.

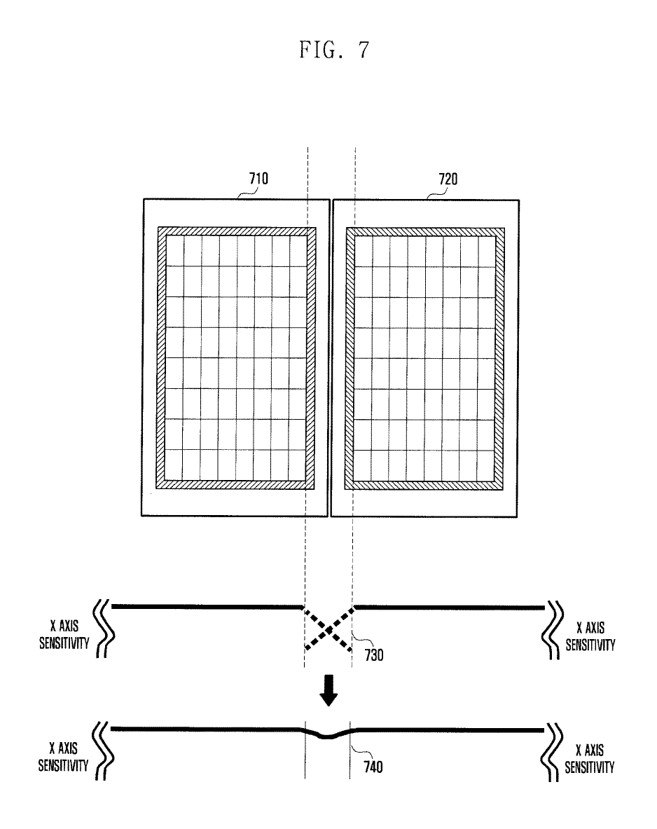

FIG. 7 is a diagram illustrating an example of a method for processing touch input performed in the input cutoff area between two electronic devices, according to aspects of the disclosure.

As shown in FIG. 7, a first and second electronic devices 710 and 720 are arranged side by side to align their view areas horizontally. In this case, the conventional method cannot detect any touch made in the input cutoff area between the first and second electronic devices 710 and 720 as denoted by reference number 730. In various embodiments of the present disclosure, the first and second electronic devices 710 and 720 share signals to keep continuity of a touch gesture made across the input cutoff area and detect the corresponding touch input. In this case, all the types of data including an icon and an audio file and the like can be transferred from the first electronic device 710 to the second electronic device 720 according to the touch & drag gesture crossing the input cutoff area. According to various embodiments, the proximity input or seamless proximity input may be made by means of an electronic device as denoted by reference number 740.

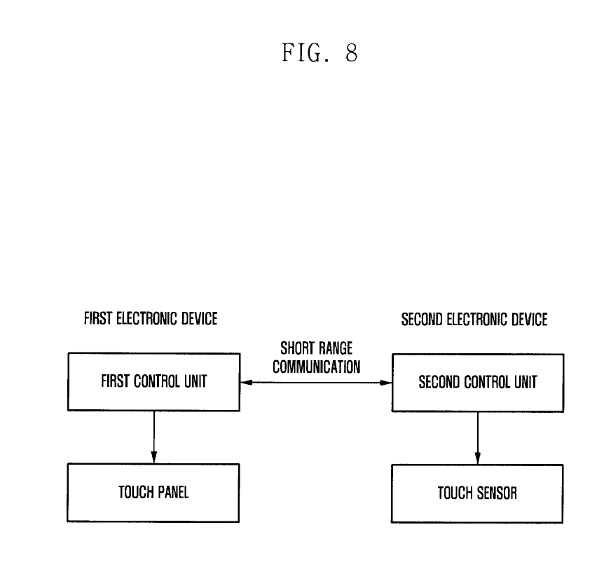

FIG. 8 is a block diagram illustrating a touch input processing operation between the electronic devices, according to aspects of the disclosure.

Referring to FIG. 8, the control units of the first and second electronic devices may communicate through a short range communication link. The first and second electronic devices may share the signal generated by the touch terminal and the touch sensor. The first electronic device detects an input generated by the touch panel and an input generated by the touch sensor. The control units of the first and second electronic devices may process the detected input in a distributed fashion. In such implementations, the control units of the first and second control units may form a vertical control unit (third control unit), and execute the operation by using the vertical control unit.

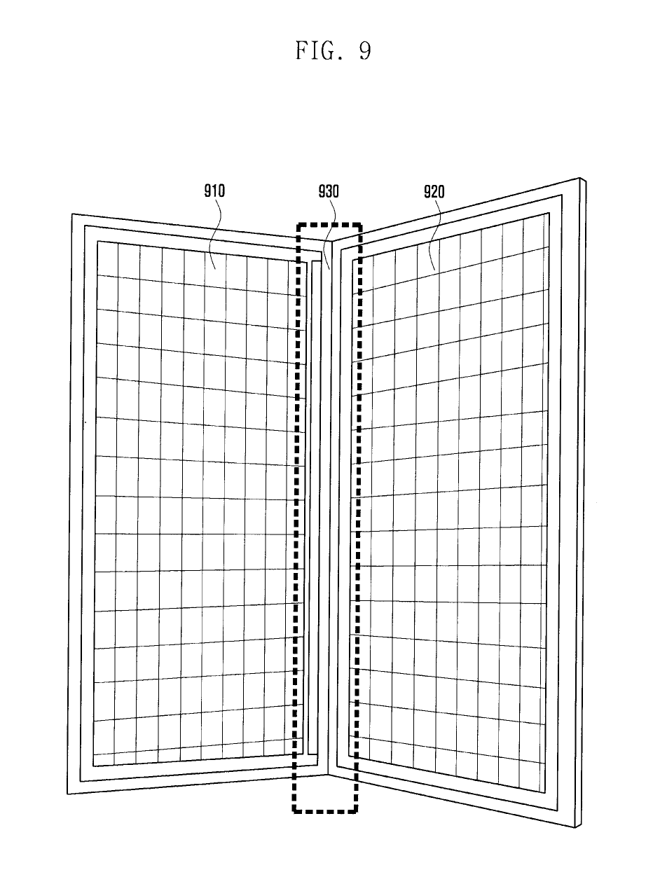

FIG. 9 is a diagram illustrating a method for processing touch input that spans multiple devices, according to aspects of the disclosure.

Referring to FIG. 9, the electronic device may forms a virtual neighbor touch panel 930 in the input cutoff area between the first and second touch panels 910 and 920. At this time, the second touch panel 920 may be the touch panel different form the first touch panel 910 in the electronic device. The virtual neighbor touch panel 930 may be formed in the bezel area between the edge area of the first touch panel 910 and the edge area of the second touch panel 920. Accordingly, the electronic device is capable of processing the touch input using the first touch signal detected in the first touch channel 910, the second touch signal detected in the second touch panel 910, and the virtual touch signal detected in the virtual neighbor touch panel 930. That is, the electronic device processes the first and second touch signals and the virtual touch signal integrally so as to process the touch input in the input cutoff area. According to a certain embodiment, the electronic device calibrates the first and second touch signal and the virtual touch signal and processes the touch input made in the input cutoff area using the calibrated signals.

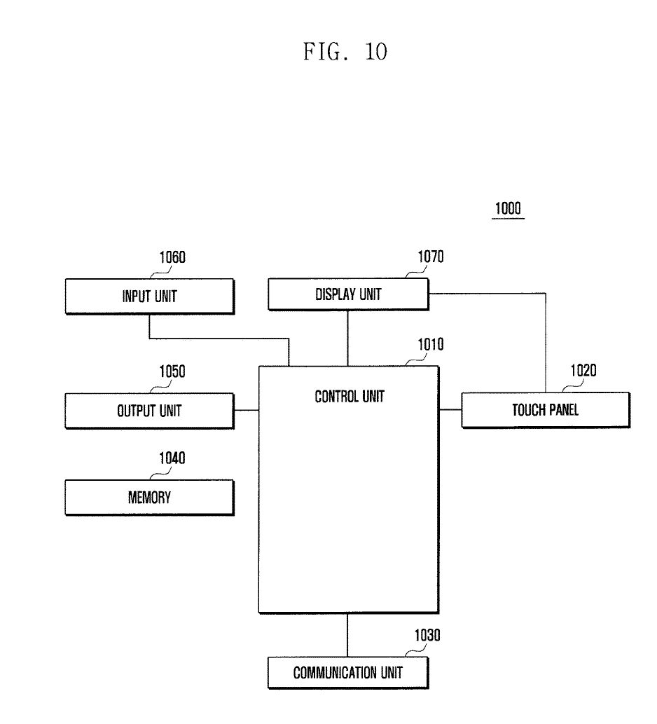

FIG. 10 is a block diagram of an example of an electronic device, according to aspects of the disclosure.

Referring to FIG. 10, the electronic device 1000 includes a control unit 1010, a touch panel 1020, a communication unit 1030, a memory 1040, an output unit 1050, an input unit 1060, and a display unit 1070.

A description is made of the first embodiment with reference to FIGS. 1 to 3 and 4A and 4B.

The touch panel 1020 may include the first touch pattern group formed regularly in the view area of the substrate and a second touch pattern group formed irregularly in the edge area surrounded by the first touch pattern group. The screen area may display the data such as texts and images. The edge area may include an area between the view area and bezel area. The bezel area is a non-view area surrounding the edge of the view area and may be printed with one or any combination of various colors such as black, white, and pink to hide wirings, contact points, and pattern arranged in the non-view area. According to a certain embodiment, the edge area may include at least part of the edge area included in the view area or part of the inner bezel area formed between the view area and the bezel area to protect against backlight bleeding

According to a certain embodiment, the touch panel 1020 may integrate the input unit 1060 and the display unit 1070. The touch panel 1020 may detect the first touch signal corresponding to a touch input using the first and second touch pattern groups. The touch panel 1020 may have the second touch pattern group in the edge area between the view area and the bezel area. According to an embodiment, the touch panel 1020 may have the first and second touch pattern groups on the same substrate or different substrates respectively. According to a certain embodiment, the touch panel 1020 may have the first and second touch pattern groups in a shape of one or any combination of a line structure, a curved structure, a diamond, a polygon, a circle, a sector shape, a tooth shape, and a star shape. According to a certain embodiment, the touch panel 1020 may have the second touch pattern group in the form obtained dividing one pattern in the first touch pattern group at a predetermined ratio or extending one pattern in the first touch pattern group at a predetermined ratio.

The control unit 1010 may include any suitable type of processing circuitry. For example, the control unit 1010 may include one or more of a general-purpose processor (e.g., an ARM-based processor), a Field-Programmable Gate Array (FPGA), an Application-Specific Integrated Circuit (ASIC), a Digital Signal Processor (DSP), or a Programmable Logic Device (PLD). In operation, the control unit 1010 may set the input thresholds of the first and second touch pattern groups to different values. The control unit 1010 is responsible for controlling all the components of the electronic device 1000. The control unit 1010 may determine whether a specific key is pressed, a communication mode configuration screen is requested, or a specific touch gesture is detected on the screen.

A description is made of the second embodiment with reference to FIGS. 5 to 8.

The communication unit 1030 may recognize the second electronic device. The communication unit 1030 may send a first touch signal to the second electronic device and receive a second touch signal detected by the touch sensor of the second electronic device. The communication unit 1030 may perform voice communication, video communication, and data communication with another electronic device through a network under the control of the control unit 1010. The communication unit 1030 may include a Radio Frequency (RF) transmitter for up-converting and amplifying the transmission signal and an RF receiver for low noise amplifying and down-converting the received signal. The communication unit 1030 may include at least one of a cellular communication module (e.g. a 3^{rd} Generation (3G) cellular communication module, a 3.5G cellular communication module, and a 4G cellular communication module), a digital broadcasting module (e.g. Digital Multimedia Broadcasting (DMB) module), and a short-range communication module (e.g. a Wi-Fi module, a Bluetooth module, and an NFC module).

The control unit 1010 may process a touch input using the first touch signal and the second touch signal. According to a certain embodiment, the control unit 1010 detects the input cutoff area between the two electronic devices and processes the touch input analogized within the input cutoff area using the first touch signal and the second touch signal. According to a certain embodiment, the control unit 1010 calibrates the first touch signal and the second touch signal and processes the touch input analogized in the input cutoff area using the calibrated signals.

According to a certain embodiment, if a touch gesture is made across the input cutoff area to the touch sensor, the communication unit 1030 may send the second electronic device the first touch signal under the control of the control unit 1010 and receive the second touch signal generated by the touch sensor in association with the first touch signal. The control unit 1010 may perform a function pertaining to the first touch signal based on the second touch signal.

According to a certain embodiment, the touch panel 1020 may include a first touch panel for detecting a first touch signal, a second touch panel for detecting a second touch signal, and a virtual neighbor touch panel formed in the input cutoff area between the first and second touch panels. The input cutoff area may be the bezel area between the edge area of the first touch panel and the edge area of the second touch panel. The control unit 1010 may process the touch input analogized in the input cutoff area using the first touch signal, the second touch signal, and the virtual touch signal detected in the virtual neighbor touch panel. According to a certain embodiment, the control unit 1010 may calibrate the first and second touch signals and the virtual touch signal and process the touch input analogized in the input cutoff area using the calibrated signals.

The memory 1040 may store pictures, documents, applications, music files, and preset parameter values and conditions. The memory 1040 may include a secondary memory unit such as a disc, a Random Access Memory (RAM), a Read Only Memory (ROM), and a flash memory.

The output unit 1050 may be an audio processing unit which outputs audio included in the multimedia control under the control of the control unit 1010. Typically, the audio processing unit includes a speaker (SPK) and a microphone (MIC) for input and output of audio signals (e.g. voice data) associated with voice recognition, voice recording, digital recording, and telephony functions. The audio processing unit may receive the audio signal from the control unit 1010, converts the digital audio signal to analog audio signal (D/A conversion), and amplify and output the analog audio signal through the speaker (SPK). The speaker (SPK) outputs the audio signal in the form of an audible sound wave. The microphone (MIC) may convert the sound waves from the human or other sound sources to audio signals.

The input unit 1060 may include a plurality of keys for inputting alphanumeric information and configuring various functions. The keys may include a menu key, a screen on/off key, a power on/off key, and a volume control key. The input unit 1060 generates a key event associated with user configuration or electronic device function control to the control unit 1010. The key event may include a power on/off event, a volume control event, a screen on/off event, and a shutter event. The control unit 1010 controls the aforementioned components in correspondence to the key events. The keys of the input unit 1060 may be called hard keys, and the key displayed on the display unit 107 may be called soft keys.

The display unit 1070 may display at least one image under the control of the control unit 1010. That is, the control unit 1010 may process (e.g. decode) the data into an image to be displayed on the screen and stores the image in a buffer, and the display unit 1070 converts the buffered image into an analog signal for display on the screen. The display unit 1070 may be implemented with one of Liquid Crystal Display (LCD), Organic Light Emitting Diodes (OLED), Active Matrix OLED (AMOLED), and Flexible Display. According to various embodiments, the display unit 1070 may be implemented in the form of a touchscreen capable of displaying data and receiving a user input.

According to various embodiments, the touch pattern of the edge area surrounding the view area irregularly so as to increase the touch recognition rate.

According to various embodiments, the first electronic device forms a virtual neighbor touch electrode with at least one second electronic device connected functionally with the first electronic device so as to use the input cutoff area efficiently.

According to various embodiment, the at least two touch input devices connected functionally to the first electronic device form a virtual neighbor electrode so as to user the input cutoff area efficiently.

FIGS. 1-10 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. An electronic device comprising:
a first touch panel;
a receiver; and
a processor configured to:
establish a connection with an external electronic device;
detect, by the first touch panel, a first signal corresponding to a touch input;
receive, by the receiver, a second signal from the external electronic device, the second signal detected by a second touch panel of the external electronic device; and
perform an operation based on the first signal and the second signal.

2. The electronic device of claim 1, wherein the first touch panel comprise a first touch pattern group formed in a first area of the first touch panel and a second touch pattern group formed in a second area of the first touch panel that surrounds the first area.

3. The electronic device of claim 2, wherein the first signal is detected based on a first threshold and a second threshold, wherein the first threshold is used in detecting an input in the first area and the second threshold is used in detecting an input in the second area.

4. The electronic device of claim 2, wherein each of touch patterns in the first touch pattern group has a first size and each of touch patterns in the second touch pattern group has a second size different from the first size.

5. The electronic device of claim 1, wherein the first signal corresponds to a touch input detected in a bezel of the electronic device, and wherein the second signal corresponds to a touch input detected in a bezel of the external electronic device.

6. The electronic device of claim 5, wherein processor is configured to: generate a third signal by extrapolating the first signal and the second signal; and perform the operation based on the third signal.

7. A method of processing a touch input of an electronic device, the method comprising:
establishing a connection with an external electronic device;
detecting, by a first touch panel of the electronic device, a first signal corresponding to a touch input;
receiving, by a receiver of the electronic device, a second signal from the external electronic device, the second signal detected by a second touch panel of the external electronic device; and
performing an operation based on the first signal and the second signal.

8. The method of claim 7, wherein the first touch panel comprise a first touch pattern group formed in a first area of the first touch panel and a second touch pattern group formed in a second area of the first touch panel that surrounds the first area.

9. The method of claim 8, wherein the first signal is detected based on a first threshold and a second threshold, and wherein the first threshold is used in detecting an input in the first area and the second threshold is used in detecting an input in the second area.

10. The method of claim 8, wherein each of touch patterns in the first touch pattern group has a first size and each of touch patterns in the second touch pattern group has a second size different from the first size.

11. The method of claim 7, wherein the first signal corresponds to a touch input detected in a bezel of the electronic device, and wherein the second signal corresponds to a touch input detected in a bezel of the external electronic device.

12. The method of claim 11, wherein performing the operation based on the first signal and the second signal comprises:
generating a third signal by extrapolating the first signal and the second signal; and
performing the operation based on the third signal.

13. An electronic device comprising:
a first touch panel;
a second touch panel; and
a processor configured to:
detect, by the first touch panel, a first signal corresponding to a touch input;
detect, by the second touch panel, a second signal corresponding to the touch input; and
perform an operation based on the first signal and the second signal.

14. The electronic device of claim 13, wherein the first touch panel comprise a first touch pattern group formed in a first area of the first touch panel and a second touch pattern group formed in a second area of the first touch panel that surrounds the first area, and
wherein the second touch panel comprise a third touch pattern group formed in a third area of the second touch panel and a fourth touch pattern group formed in a fourth area of the second touch panel that surrounds the third area.

15. The electronic device of claim 14, wherein the first signal is detected based on a first threshold and a second threshold, wherein the first threshold is used in detecting an input in the first area and the second threshold is used in detecting an input in the second area, and
wherein the second signal is detected based on a third threshold and a fourth threshold, wherein the third threshold is used in detecting an input in the third area and the fourth threshold is used in detecting an input in the fourth area.

16. The electronic device of claim 14, wherein each of touch patterns in the first touch pattern group has a first size and each of touch patterns in the second touch pattern group has a second size different from the first size, and
wherein each of each of touch patterns in the third touch pattern group has a third size and each of touch patterns in the fourth touch pattern group has a fourth size different from the third size.

17. The electronic device of claim 13, wherein at least one of the first signal or the second signal corresponds to a touch input detected in the bezel of the electronic device.

18. The electronic device of claim 17, wherein processor is configured to: generate a third signal by extrapolating the first signal and the second signal; and perform the operation based on the third signal.
